(19) United States
(12) Patent Application Publication
(10) Pub. No.: US 2025/0220583 A1
(43) Pub. Date: Jul. 3, 2025

(54) SYSTEM, METHOD, AND INFORMATION PROCESSING DEVICE

(71) Applicant: TOYOTA JIDOSHA KABUSHIKI KAISHA, Toyota-shi (JP)

(72) Inventors: Hiroshi ABE, Kasukabe-shi (JP); Chunghan LEE, Yokohama-shi (JP); Lei ZHONG, Tokyo (JP); Toru FURUSAWA, Yokohama-shi (JP); Satoshi OMI, Tokyo (JP)

(73) Assignee: TOYOTA JIDOSHA KABUSHIKI KAISHA, Toyota-shi (JP)

(21) Appl. No.: 19/000,296

(22) Filed: Dec. 23, 2024

(30) Foreign Application Priority Data
Dec. 27, 2023 (JP) 2023-221535

(51) Int. Cl. H04W 52/02

(52) U.S. Cl. CPC H04W 52/0235

(57) ABSTRACT

A system includes: a plurality of nodes in each of which at least one container is deployed; and an information processing device including a control unit. The control unit is configured to: transmit, to a first node out of the plurality of nodes, a first request for instruction to move one or more containers deployed in the first node to a second node out of the plurality of nodes; and transmit an instruction for transition to a power saving state to the first node when no container is present on the first node.

### CROSS-REFERENCE TO RELATED APPLICATION

This application claims priority to Japanese Patent Application No. 2023-221535 filed on Dec. 27, 2023, incorporated herein by reference in its entirety.

### BACKGROUND

### 1. Technical Field

The present disclosure relates to a system, a method, and an information processing device, for example, a virtualization system.

### 2. Description of Related Art

There is disclosed a container redeployment system in which, when a data communication amount between containers generated on different second servers exceeds a threshold, a first server redeploys at least one of a pair of communication amount excess containers associated with the data communication amount exceeding the threshold so that the communication amount excess containers are deployed in the same second server (e.g., Japanese Unexamined Patent Application Publication No. 2022-070307 (JP 2022-070307 A)).

### SUMMARY

One aspect of the present disclosure provides a system, a method, and an information processing device capable of reducing the power consumption of the entire system.

One aspect of the present disclosure is a system including: a plurality of nodes in each of which at least one container is deployed; and an information processing device including a control unit. The control unit is configured to: transmit, to a first node out of the plurality of nodes, a first request for instruction to move one or more containers deployed in the first node to a second node out of the plurality of nodes; and transmit an instruction for transition to a power saving state to the first node when no container is present on the first node.

The control unit may be configured to: transmit the first request to a plurality of the first nodes; and transmit the instruction for transition to the power saving state to the first nodes when no container is present on each of the first nodes.

The control unit may further be configured to determine, as the second node, a node included in a predetermined number of top nodes where a larger number of containers are deployed out of the plurality of nodes.

The control unit may be configured to: when the one or more containers deployed in the first node are not movable to the second node, determine, as a new second node, a node included in a predetermined number of top nodes where a larger number of containers are deployed out of the plurality of nodes; and transmit, to the first node, the first request for instruction to move the one or more containers deployed in the first node to the new second node.

Each of the nodes may be configured to: when the first request is received from the information processing device, determine whether to execute movement of the one or more containers to the second node; when determination is made to execute the movement of the one or more containers to the second node, execute a process related to the movement of the one or more containers to the second node; and when determination is made not to execute the movement of the one or more containers to the second node, notify the information processing device that the movement of the one or more containers to the second node is not to be executed.

Each of the nodes may be configured to: monitor a power consumption of the one or more deployed containers; and when the first request is received, determine whether to execute the movement of the one or more containers to the second node based on the power consumption of the one or more containers and a maximum power consumption and a current power consumption of the second node.

The control unit may be configured to: determine the first node among the plurality of nodes based on the number of deployed containers.

The control unit may further be configured to, when a group of a plurality of first containers configured to execute the same service is present among the nodes, transmit, before transmitting the first request, a second request for instruction to delete the first container to one or more nodes where one or more remaining first containers other than one first container in the group are deployed.

The container may be any function in a core network of a mobile communication network.

The container may be an instance of any network function in a core network of a fifth-generation mobile communication network.

The control unit may further be configured to: when the container is newly deployed in the second node as a new first network function instance after the first request is transmitted, transmit, to a second network function instance, a second request for instruction for switching from an old first network function instance deployed in the first node to the new first network function instance deployed in the second node; and when the switching from the old first network function instance to the new first network function instance is completed, transmit an instruction to delete the old first network function instance to the first node.

Another aspect of the present disclosure is a method including: transmitting, by an information processing device, to a first node out of a plurality of nodes in each of which at least one container is deployed, a first request for instruction to move one or more containers deployed in the first node to a second node out of the plurality of nodes; and transmitting, by the information processing device, an instruction for transition to a power saving state to the first node when no container is present on the first node.

The method may further include: transmitting, by the information processing device, the first request to a plurality of the first nodes; and transmitting, by the information processing device, the instruction for transition to the power saving state to the first nodes when no container is present on each of the first nodes.

The method may further include determining, by the information processing device, as the second node, a node included in a predetermined number of top nodes where a larger number of containers are deployed out of the plurality of nodes.

The method may further include: when the one or more containers deployed in the first node are not movable to the second node, determining, by the information processing device, as a new second node, a node included in a predetermined number of top nodes where a larger number of containers are deployed out of the plurality of nodes; and transmitting, by the information processing device, to the first node, the first request for instruction to move the one or more containers deployed in the first node to the new second node.

The method may further include executing, by each of the nodes: when the first request is received from the information processing device, determining whether to execute movement of the one or more containers to the second node; when determination is made to execute the movement of the one or more containers to the second node, executing a process related to the movement of the one or more containers to the second node; and when determination is made not to execute the movement of the one or more containers to the second node, notify the information processing device that the movement of the one or more containers to the second node is not to be executed.

The method may further include executing, by each of the nodes: monitoring a power consumption of the one or more deployed containers; and when the first request is received, determining whether to execute the movement of the one or more containers to the second node based on the power consumption of the one or more containers and a maximum power consumption and a current power consumption of the second node.

In the method, the container may be an instance of any network function in a core network of a fifth-generation mobile communication network.

The method may further include: when the container is newly deployed in the second node as a new first network function instance after the first request is transmitted, transmitting, by the information processing device, to a second network function instance, a second request for instruction for switching from an old first network function instance deployed in the first node to the new first network function instance deployed in the second node; and when the switching from the old first network function instance to the new first network function instance is completed, transmitting, by the information processing device, an instruction to delete the old first network function instance to the first node.

Another aspect of the present disclosure is an information processing device including a control unit configured to: transmit, to a first node out of a plurality of nodes in each of which at least one container is deployed, a first request for instruction to move one or more containers deployed in the first node to a second node out of the plurality of nodes; and transmit an instruction for transition to a power saving state to the first node when no container is present on the first node.

According to the present disclosure, it is possible to reduce the power consumption of the entire system.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows an example of a system configuration of a virtualization system according to a first embodiment;

FIG. 2 shows an example of a hardware configuration of a controller;

FIG. 3 shows an example of a functional configuration of the controller;

FIG. 4 shows an example of information stored in a pod information database (DB) of the controller;

FIG. 5 shows an example of information stored in a node information DB;

FIG. 6 shows an example of a functional configuration of a node;

FIG. 7 shows an example of a flowchart of a container aggregation process by the controller;

FIG. 8 shows an example of a flowchart of a process to be executed by the node when a container movement instruction is received;

FIG. 9 shows an example of a sequence of the container aggregation process in the virtualization system;

FIG. 10 shows an example of the sequence of the container aggregation process in the virtualization system;

FIG. 11A shows an example of a sequence of the container aggregation process when the virtualization system is applied to a 5G core network system;

FIG. 11B shows another example of the sequence of the container aggregation process when the virtualization system is applied to the 5G core network system;

FIG. 12A shows an example of a sequence of an instance switching process in the 5G core network when a pod is an instance of a user plane function (UPF);

FIG. 12B shows the example of the sequence of the instance switching process in the 5G core network when the pod is the instance of the UPF;

FIG. 13A shows an example of a sequence of the instance switching process in the 5G core network when the pod is an instance of a session management function (SMF);

FIG. 13B shows the example of the sequence of the instance switching process in the 5G core network when the pod is the instance of the SMF;

FIG. 14A shows an example of a sequence of the instance switching process in the 5G core network when the pod is an instance of an access and mobility management function (AMF); and

FIG. 14B shows the example of the sequence of the instance switching process in the 5G core network when the pod is the instance of the AMF.

### DETAILED DESCRIPTION OF EMBODIMENTS

One aspect of the present disclosure is a system including a plurality of nodes and an information processing device. In each of the nodes, at least one container is deployed. The information processing device includes a control unit. The control unit is configured to: transmit, to a first node out of the plurality of nodes, a first request for instruction to move one or more containers deployed in the first node to a second node out of the plurality of nodes; and transmit an instruction for transition to a power saving state to the first node when no container is present on the first node.

Examples of the system according to the one aspect of the present disclosure include a virtual computing system, a distributed computing system, and an edge computing system. Examples of the node according to the one aspect of the present disclosure include a physical server. When the system is edge computing, the node is an edge node. The container may be any function in a core network of a mobile communication network. Alternatively, the container may be any network function in a core network of a fifth-generation mobile communication network. The container is not limited to these.

Examples of the information processing device according to the one aspect of the present disclosure include a controller that manages the containers. Examples of the information processing device include a dedicated computer. The information processing device is not limited to this. The control unit is a processor such as a central processing unit (CPU).

When the instruction for transition to the power saving state is received from the information processing device, the first node makes transition to the power saving state. The power saving state is a state in which the power supply is stopped, a state in which the power supply to the node is stopped without stopping the power supply to part of the hardware, or any other state in which no electric power is consumed or the power consumption is smaller than that in the operating state.

In the one aspect of the present disclosure, the amount of electric power consumed by the first node is reduced by aggregating the containers into the second node and bringing the first node where no container is present into the power saving state. Thus, it is possible to reduce the power consumption of the entire system.

The control unit may be configured to: transmit the first request to a plurality of the first nodes; and transmit the instruction for transition to the power saving state to the first nodes when no container is present on each of the first nodes. As the number of first nodes that are brought into the power saving state increases, the power consumption can be reduced.

The control unit may further be configured to determine, as the second node, a node included in a predetermined number of top nodes where a larger number of containers are deployed out of the plurality of nodes. As the number of containers to be moved increases, the amount of electric power consumed to move the containers increases. By determining the node where a large number of containers are deployed as the second node to which the containers will be moved, the power consumption related to the movement of the containers can be reduced.

The control unit may be configured to: when the containers deployed in the first node are not movable to the second node, determine, as a new second node, a node included in a predetermined number of top nodes where a larger number of containers are deployed out of the plurality of nodes; and transmit, to the first node, the first request for instruction to move the containers to the new second node. When the containers on the first node are not movable to the second node, a new second node is selected from among the predetermined number of top nodes where a larger number of containers are deployed. Thus, it is possible to minimize the power consumption of the entire system.

Each of the nodes may be configured to: when the first request is received from the information processing device, determine whether to execute movement of the one or more containers to the second node; when determination is made to execute the movement of the one or more containers to the second node, move the one or more containers to the second node; and when determination is made not to execute the movement of the one or more containers to the second node, notify the information processing device that the movement of the one or more containers to the second node is not to be executed. The processing load on the information processing device can be reduced when the node that receives the first request as the first node determines whether to move the containers from the first node to the second node.

Each of the nodes may be configured to: monitor a power consumption of the one or more deployed containers; and when the first request is received, determine whether to execute the movement of the one or more containers to the second node based on the power consumption of the one or more containers and a maximum power consumption and a current power consumption of the second node. Therefore, it is possible to more accurately determine whether the containers are movable. Thus, it is possible to reduce failures in container movement as in the case where the container movement is started but the containers cannot be operated at the second node.

The control unit may be configured to determine the first node among the plurality of nodes based on the number of deployed containers. For example, by determining the first node among the predetermined number of top nodes where a smaller number of containers are deployed, it is possible to increase the number of nodes where no container is deployed and that are brought into the power saving state. Thus, it is possible to further reduce the power consumption of the entire system.

The control unit may further be configured to, when a plurality of first containers configured to execute the same service is present among the nodes, transmit, before transmitting the first request, a second request for instruction to delete the first container to one or more nodes where one or more remaining first containers other than one first container are deployed. By reducing redundant containers, the power consumption of the entire system can be reduced. In addition, the number of containers to be moved can be reduced, and the power consumption related to the movement of the containers can be reduced.

As another aspect of the present disclosure, the process to be executed in the above system can be specified as a method. The method includes: transmitting, by an information processing device, to a first node out of a plurality of nodes in each of which at least one container is deployed, a first request for instruction to move one or more containers deployed in the first node to a second node out of the plurality of nodes; and transmitting, by the information processing device, an instruction for transition to a power saving state to the first node when no container is present on the first node.

As another aspect of the present disclosure, an information processing device included in the above system can be specified. The information processing device includes a control unit. The control unit is configured to: transmit, to a first node out of a plurality of nodes in each of which at least one container is deployed, a first request for instruction to move one or more containers deployed in the first node to a second node out of the plurality of nodes; and transmit an instruction for transition to a power saving state to the first node when no container is present on the first node. In addition, the one aspect of the present disclosure can be specified as an information processing device included in the above system, a program for causing a computer to execute the process on each of the nodes, and a non-transitory computer-readable recording medium on which the program is recorded.

Hereinafter, embodiments of the present disclosure will be described with reference to the drawings. The configurations of the embodiments described below are illustrative, and the present disclosure is not limited to the configurations of the embodiments.

### First Embodiment

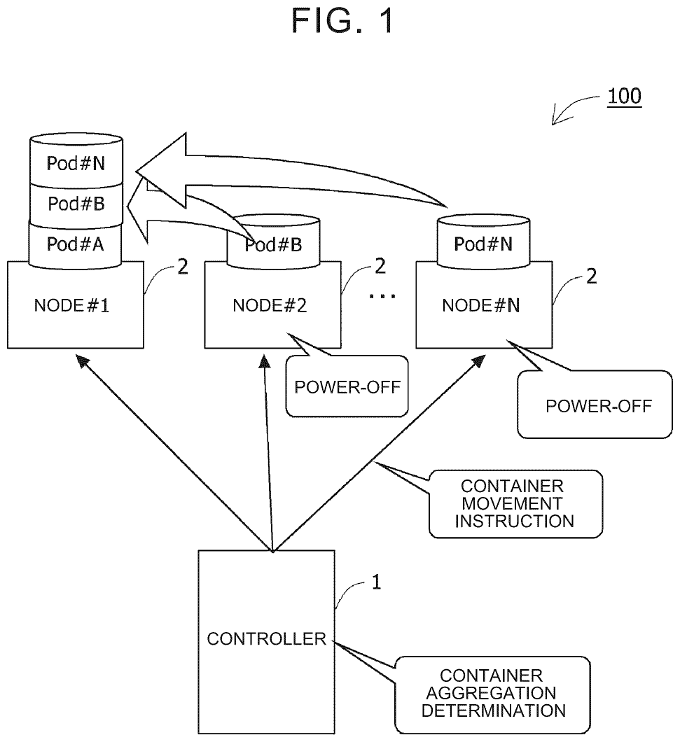

FIG. 1 shows an example of a system configuration of a virtualization system 100 according to a first embodiment. The virtualization system 100 is a container-type virtualization system. The virtualization system 100 includes a controller 1 and a plurality of nodes 2 where containers are deployed. The term “nodes 2” indicates that no distinction is made between the nodes and description is given of all the nodes. For example, when the virtualization system 100 is an edge computing system, the node 2 is an edge server deployed in each area to process application requests from a terminal at a location closer to the terminal than a cloud. The virtualization system 100 is not limited thereto, and may be a distributed computing system.

The controller 1 and each node 2 are connected to a network and are capable of communicating with each other via the network. Examples of the network to which the controller 1 and the nodes 2 are connected include a local area network (LAN), a public line network such as the Internet, or a backbone network such as an optical line network.

The controller 1 is a device that manages the nodes 2 and containers. In the first embodiment, the controller 1 executes Kubernetes and manage containers. The system that is used to manage containers is not limited to Kubernetes. In the first embodiment, the controller 1 reduces the power consumption of the entire virtualization system 100 by aggregating containers into part of the nodes 2 and powering off nodes 2 where no container is deployed.

More specifically, for example, when the processing demand on the virtualization system 100 decreases, the controller 1 determines to aggregate containers into part of the nodes 2. The controller 1 determines, for example, a node 2 from which a pod is to be moved to another node and a node 2 to which the pod is to be moved based on the number of pods currently in operation. The pod is a set of containers required to provide a service. In the first embodiment, the containers are moved in units of pods. The pod contains one or more containers.

In the first embodiment, the controller 1 determines a node 2 where the largest number of pods are deployed as the node 2 to which the pod is to be moved. The node 2 to which the pod is to be moved is hereinafter referred to as “destination node.” In the first embodiment, the controller 1 determines a node 2 where the smallest number of pods are deployed as the node 2 from which a pod is to be moved to another node 2. The node 2 from which a pod is to be moved to another node 2 is hereinafter referred to as “source node.” The selection of the destination node and the source node is not limited to the use of the number of deployed pods, but, for example, the power consumption of the node 2 may be used. For example, a node 2 having the largest power consumption may be selected as the destination node. The source node is an example of a “first node.” The destination node is an example of a “second node.”

The controller 1 transmits an instruction to the source node to move a container to the destination node. When the source node receives the container movement instruction, the source node moves its deployed pod to the destination node. Then, the controller 1 transmits a power-off instruction to the node 2 where no pod is deployed. The node 2 that receives the power-off instruction is powered off. The process of aggregating containers into part of the nodes 2 and powering off the nodes where no container is deployed is hereinafter referred to as “container aggregation process.” The container movement instruction is an example of a “first request.” The power-off instruction is an example of an “instruction for transition to a power saving state.”

For example, in FIG. 1, pod #A is deployed in node #1. Pod #B is deployed in node #2. Pod #N is deployed in node #N. For example, it is assumed that the controller 1 selects nodes #2 and #N as source nodes and node #1 as a destination node. In this case, the controller 1 transmits a container movement instruction to nodes #2 and #N, specifying node #1 as the destination node. When receiving the container movement instruction, nodes #2 and #N move pods #B and #N to node #1, respectively. Therefore, each of nodes #2 and #N has no pod deployed, and the controller 1 transmits a power-off instruction to nodes #2 and #N. When receiving the power-off instruction, nodes #2 and #N are powered off. This reduces the amount of electric power consumed by nodes #2 and #N.

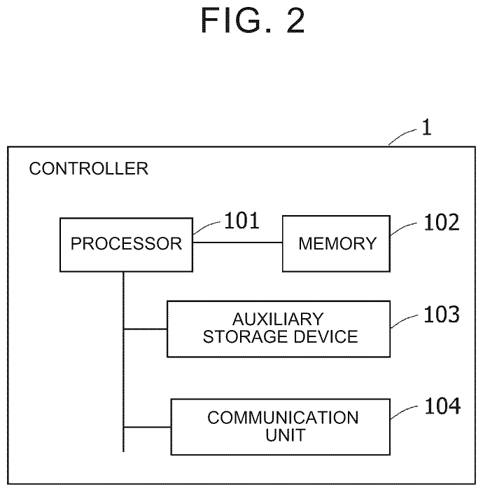

FIG. 2 shows an example of a hardware configuration of the controller 1. The controller 1 is, for example, a dedicated computer. The controller 1 is not limited to the dedicated computer. The controller 1 includes a processor 101, a memory 102, an auxiliary storage device 103, and a communication unit 104 as the hardware configuration. The memory 102 and the auxiliary storage device 103 are computer-readable recording media. The controller 1 is an example of an “information processing device.” The processor 101, the auxiliary storage device 103, and the communication unit 104 are electrically connected to each other by a bus.

The auxiliary storage device 103 stores various programs and data to be used by the processor 101 to execute the programs. Examples of the auxiliary storage device 103 include an erasable programmable read only memory (EPROM) and a hard disk drive (HDD). Examples of the programs held in the auxiliary storage device 103 include an operating system (OS), container orchestration software such as Kubernetes, a container aggregation program, and various other application programs.

The memory 102 is a storage device that provides the processor 101 with a storage area and a working area for loading the programs stored in the auxiliary storage device 103 and that is used as a buffer. The memory 102 includes a semiconductor memory such as a read only memory (ROM) and a random access memory (RAM).

The processor 101 executes various processes by loading the OS and various other application programs held in the auxiliary storage device 103 into the memory 102 and executing them. Examples of the processor 101 include a central processing unit (CPU) and a digital signal processor (DSP). The number of processors 101 is not limited to one, and a plurality of processors may be provided. The processor 101 is an example of a “control unit.”

Examples of the communication unit 104 include a network interface card (NIC) and an optical line interface. The communication unit 104 is connected to a wired network such as a local area network (LAN) or an optical line network.

The hardware configuration of the controller 1 is not limited to that shown in FIG. 2. Similarly to the controller 1, the node 2 includes a processor, a memory, an auxiliary storage device, and a communication unit. The auxiliary storage device of the node 2 stores, for example, an OS, container orchestration software “Kubernetes,” and a container platform such as Docker.

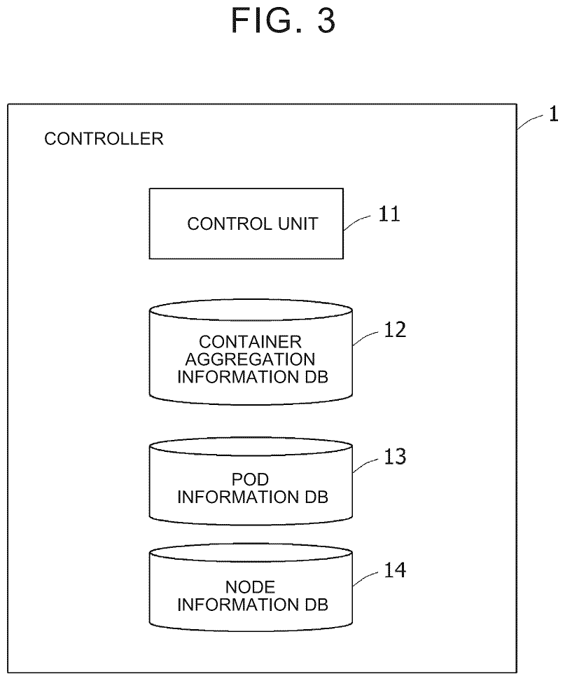

FIG. 3 shows an example of a functional configuration of the controller 1. The controller 1 includes a control unit 11, a container aggregation information DB 12, a pod information DB 13, and a node information DB 14 as the functional configuration. The processes by these functional components are achieved by the processor 101 of the controller 1 executing a predetermined program.

The control unit 11 controls the container aggregation process. More specifically, the control unit 11 starts the container aggregation process when a container aggregation condition is satisfied. The container aggregation condition is, for example, that the processing demand on the virtualization system 100 is low. For example, when the virtualization system 100 is applied to a core network of a communication network, the container aggregation condition is nighttime hours when communication demand is low. The communication demand is acquired as statistical information based on actual measurement values, for example, for each day of the week and each time frame. It has been found that the communication demand is generally lower during the nighttime hours when human activity decreases. When sport events such as the World Cup are held outside Japan, it is predicted that the communication demand will be high even at night. Therefore, the container aggregation condition is the nighttime hours when the communication demand is low, and no global events scheduled. The container aggregation condition is not limited to these. For example, the container aggregation condition may be an AND condition such as a condition that the length of time during which the reception demand is low is equal to or larger than a predetermined length of time. The container aggregation condition is set by an administrator of the virtualization system 100 depending on the type of system to which the virtualization system 100 is applied.

When the container aggregation process is started, the control unit 11 determines a source node and a destination node. In the first embodiment, the control unit 11 refers to the pod information DB 13 described later, and determines the destination node from among a predetermined number of top nodes 2 where a larger number of pods are deployed. In the first embodiment, a node 2 where the largest number of pods are deployed is determined as the destination node. When there is a plurality of nodes 2 where the largest number of pods are deployed, the control unit 11 may select, for example, any one of the nodes 2 as the destination node.

The control unit 11 refers to the pod information DB 13, and determines the source node from among a predetermined number of top nodes 2 where a smaller number of pods are deployed. In the first embodiment, the node 2 with the smallest number of pods is determined as the source node. A plurality of source nodes may be selected.

The control unit 11 transmits, to the source node, a container movement instruction for movement of a pod to the destination node. When no pods are deployed in the source node, a power-off instruction is transmitted to the source node.

The container aggregation information DB 12, the pod information DB 13, and the node information DB 14 are created in the storage area of the auxiliary storage device 103. The container aggregation information DB 12 stores information on the container aggregation condition. For example, when the virtualization system 100 is applied to a core network of a communication system and the container aggregation condition is a time frame when the communication demand is lower than a predetermined value and no global events to be held, the container aggregation information DB 12 stores prediction information on the communication demand for each day of the week and each time frame, and information on scheduled global events. The communication demand may be represented by any one or a combination of the number of connected terminals per unit time, the communication amount per unit time, etc.

The pod information DB 13 stores information on pods. The node information DB 14 stores information on the nodes 2. The information stored in the pod information DB 13 and the node information DB 14 will be described in detail later. The functional configuration of the controller 1 is not limited to the example shown in FIG. 3.

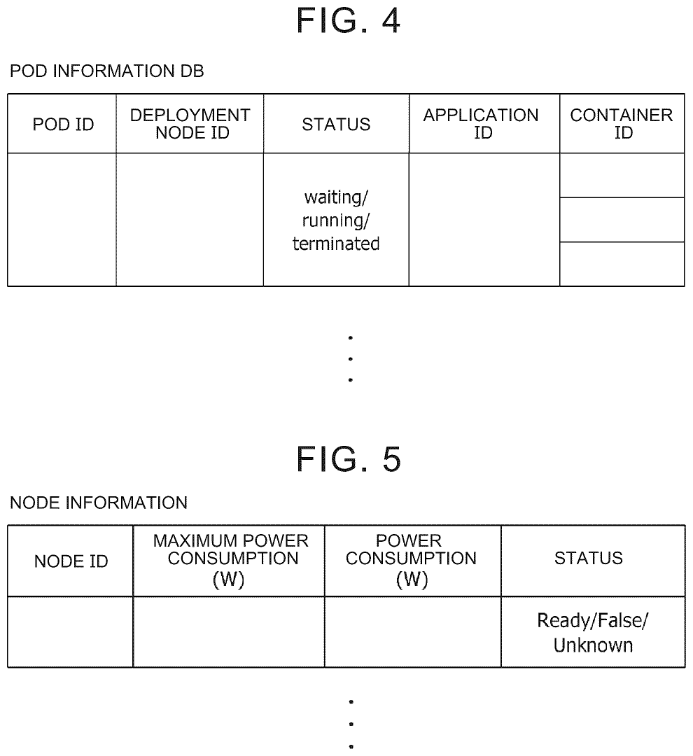

FIG. 4 shows an example of the information stored in the pod information DB 13 of the controller 1. The pod information DB 13 stores information on pods. In the example shown in FIG. 4, one record in the pod information DB 13 is associated with one pod. One record in the pod information DB 13 includes fields for a pod identifier (ID), a deployment node ID, a status, an application ID, and a container ID.

The pod ID field stores identification information of the pod. The pod identification information may be a character string indicating a name set as desired by the administrator of the virtualization system 100, or may be a character string automatically assigned by the control unit 11. The deployment node ID field stores identification information of the node where the pod is deployed.

The status field stores, for example, information indicating the status of the pod. The pod status may be, for example, “Waiting,” “Running,” or “Terminated.” The information indicating the status of the pod is, for example, any one of a code, a flag, or a character string indicating any one of the states of the pod.

The application ID field includes, for example, identification information of an application associated with the pod. The identification information of the application may be included as part of the identification information of the pod. In this case, the application ID field may be omitted. The container ID field includes a list of containers included in the pod.

Each pod transmits pod information that is information on the pod to the controller 1, for example, at predetermined time intervals. The control unit 11 receives the pod information from each pod. The pod information includes, for example, identification information of the pod, identification information of the deployment node 2, and the status of the pod. The control unit 11 stores the received pod information in the pod information DB 13. Therefore, the record of the corresponding pod in the pod information DB 13 is updated. When a new pod is added to the virtualization system 100, pod information on the new pod starts to be received. Therefore, the control unit 11 adds a record of the new pod to the pod information DB 13. Thus, the control unit 11 recognizes that the new pod has been added to the virtualization system 100. When a pod is deleted from the virtualization system 100, the pod information on the pod is no longer received, and the record of the pod in the pod information DB 13 is not updated for a predetermined period. When the record is not updated for the predetermined period in the pod information DB 13, the record is deleted. Thus, the control unit 11 recognizes that the pod has been deleted from the virtualization system 100. The method for detecting addition and deletion of a pod is not limited to the above method. The information held in the pod information DB 13 is not limited to the information shown in FIG. 4.

FIG. 5 shows an example of information stored in the node information DB 14. The node information DB 14 stores information on the nodes 2. One record in the node information DB 14 is associated with one node. The record in the node information DB 14 includes fields for a node ID, a maximum power consumption, a power consumption, and a status.

The node ID field stores identification information of the node 2. The maximum power consumption field stores a value of the maximum power consumption of the node 2. The power consumption field stores a value of the power consumption of the node 2. The unit of power consumption is watts (W) or kilowatts (kW).

The status field stores information indicating the status of the node 2. The status of the node 2 may be, for example, “Ready,” “False,” or “Unknown.” When the status of the node 2 is “Ready,” a pod is deployable in the node 2. When the status of the node 2 is not “Ready,” no pod is deployable in the node 2. When the node 2 is in a power-off state or a power saving state, for example, the status field may store power-off information indicating the power-off state. For example, when a notification of the result of the power-off process is received from the node 2, the control unit 11 may store the power-off information in the status field.

In the virtualization system 100, the node 2 transmits node information that is information on the node 2 to the controller 1, for example, at a predetermined cycle. The control unit 11 receives the node information from the node 2 at the predetermined cycle. The node information includes, for example, identification information of the node, a maximum power consumption, a power consumption, and a status. When the control unit 11 receives the node information from the node 2, the control unit 11 updates the corresponding record in the node information DB 14 with the received node information.

The control unit 11 transmits, to the source node, the identification information, the maximum power consumption, and the power consumption of the destination node together with the container movement instruction. The node information transmitted from the node 2 and the information stored in the node information DB 14 are not limited to the information shown in FIG. 5.

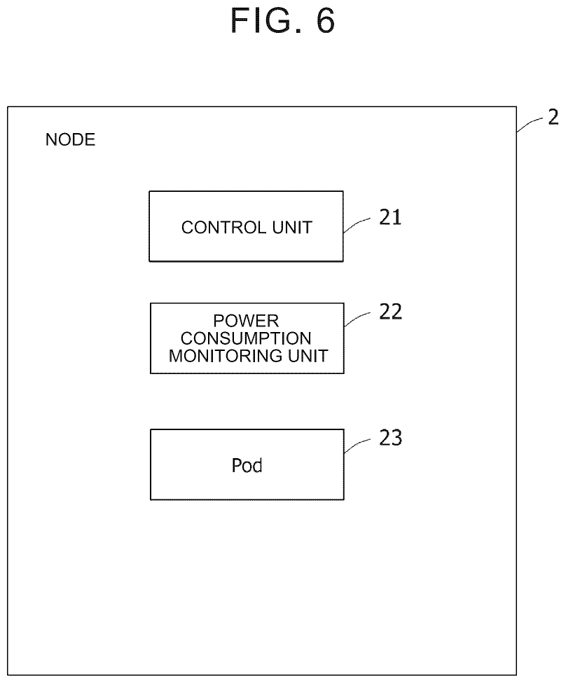

FIG. 6 shows an example of a functional configuration of the node 2. The node 2 includes a control unit 21, a power consumption monitoring unit 22, and a container 23 as the functional configuration. The processes by these functional components are achieved by the processor of the node 2 executing a predetermined program.

One or more containers 23 are included in the node 2. For convenience, only one container 23 is shown in FIG. 6. The power consumption monitoring unit 22 monitors the power consumption of each container 23.

When the node 2 is selected as the source node, the control unit 21 receives, from the controller 1, a container movement instruction and identification information, a maximum power consumption, and a power consumption of the destination node. The control unit 21 determines whether to move the container 23 to the destination node. In the first embodiment, the control unit 21 determines to move the container 23 to the destination node when the sum of the power consumption of the destination node and the power consumption of the container 23 is smaller than the maximum power consumption of the destination node. When the sum of the power consumption of the destination node and the power consumption of the container 23 is equal to or larger than the maximum power consumption of the destination node, the control unit 21 determines not to move the container 23 to the destination node, and transmits a container movement impossibility response to the controller 1 in response to the container movement instruction.

When there is a plurality of containers 23, the control unit 21 may determine whether to move all the containers 23 to the destination node, or may determine whether to move each container 23 to the destination node. When determination is made as to whether to move each container 23 to the destination node and, for example, there is even one container 23 that is not to be moved to the destination node, the control unit 21 may transmit the container movement impossibility response to the controller 1.

When determination is made to move the container 23 to the destination node, the control unit 21 moves the container 23 to the destination node. The container 23 may be moved through an interaction between the control unit 21 and the destination node. Alternatively, the container 23 may be moved by the controller 1 deploying a new pod corresponding to the container 23 in the destination node and deleting the container 23 from the node 2 that is the source node. In the latter case, when determination is made to move the container 23 to the destination node, the control unit 21 may transmit a container movement possibility response to the controller 1.

When a power-off instruction is received from the controller 1, the control unit 21 executes a power-off process. In the power-off process, the control unit 21 powers off the node 2. The functional configuration of the node 2 is not limited to the example shown in FIG. 6.

### Processing Flows

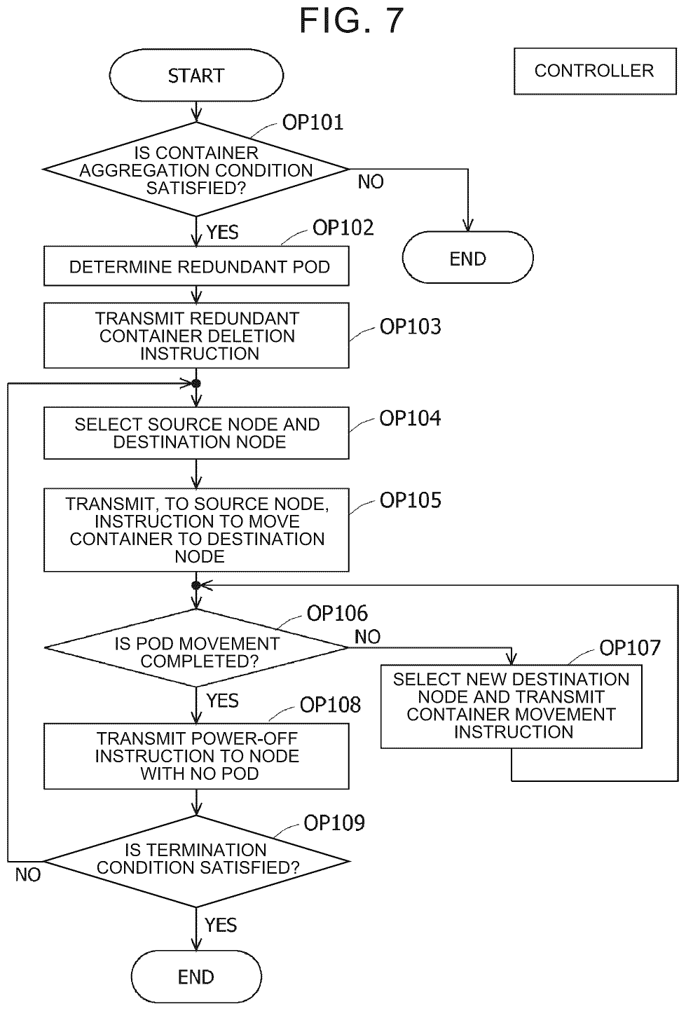

FIG. 7 shows an example of a flowchart of the container aggregation process by the controller 1. The process shown in FIG. 7 is repeated, for example, at a predetermined cycle. Although the process shown in FIG. 7 is executed, for example, by the processor 101 of the controller 1, description will be given under the assumption that the process is executed by functional components for convenience.

In OP101, the control unit 11 determines whether the container aggregation condition is satisfied. When the container aggregation condition is satisfied (OP101: YES), the process proceeds to OP102. When the container aggregation condition is not satisfied (OP101: NO), the process shown in FIG. 7 is terminated.

In OP102, the control unit 11, for example, refers to the pod information DB 13 and determines a redundant pod among a plurality of pods that executes the same application. The redundant pod is a pod other than one certain pod out of a group of the plurality of pods that executes the same application. For example, the control unit 11 determines, as the redundant pod, a pod other than the pod on the node 2 where the largest number of pods are deployed.

In OP103, the control unit 11 transmits a redundant container deletion instruction to the node 2 where the redundant pod determined in OP102 is deployed. Identification information of the pod to be deleted is transmitted together with the redundant container deletion instruction. The node 2 that receives the redundant container deletion instruction deletes the specified pod. The control unit 11 executes the process of deleting the redundant pod in OP102 and OP103 for each application executed in the virtualization system 100. Through the process in OP102 and OP103, the number of pods for each application executed in the virtualization system 100 is one. Therefore, the virtualization system 100 has a minimum configuration required for operating the system. In the process in OP102 and OP103, the number of pods to be left may be variable based on the number of requests to the application, etc.

When there is an idle pod in addition to the redundant pod, the control unit 11 may transmit an instruction to delete the idle pod to the node 2 where the idle pod is deployed.

In OP104, the control unit 11, for example, refers to the pod information DB 13 and selects a source node and a destination node. In the first embodiment, the control unit 11 selects, as the source node, a node 2 where the smallest number of pods are deployed. The control unit 11 selects, as the destination node, a node 2 where the largest number of pods are deployed.

In OP105, the control unit 11 transmits a container movement instruction to the source node. For example, identification information, a maximum power consumption, and a power consumption of the destination node are transmitted together with the container movement instruction. The identification information, the maximum power consumption, and the power consumption of the destination node are acquired from the node information DB 14.

In OP106, the control unit 11 determines whether the movement of the pod from the source node to the destination node is completed. For example, when the control unit 11 starts receiving pod information on the moved pod from the destination node and the record of the corresponding pod in the pod information DB 13 is updated, the determination in OP106 is affirmative. For example, when the control unit 11 receives a container movement impossibility response from the source node, the determination in OP106 is negative. When the movement of the pod from the source node to the destination node is completed (OP106: YES), the process proceeds to OP108.

When the pod is not moved from the source node to the destination node (OP106: NO), the process proceeds to OP107. In OP107, the control unit 11 selects a new destination node, and transmits a container movement instruction to the source node where the pod has not been moved. For example, identification information, a maximum power consumption, and a power consumption of the new destination node are transmitted together with the container movement instruction. The control unit 11 selects, as the new destination node, a node 2 where the next largest number of pods are deployed after the original destination node.

In OP108, the control unit 11, for example, refers to the pod information DB 13 and transmits a power-off instruction to the node where no pod is deployed. In OP109, the control unit 11 determines whether a termination condition is satisfied. The termination condition is set to, for example, one or more of the following: the number of nodes where pods are deployed is equal to or smaller than a threshold, the number of nodes 2 that have been powered off is equal to or larger than a threshold, and no more pod can be moved. When the termination condition includes a plurality of conditions, for example, the termination condition is an OR condition. The termination condition is not limited to these.

When the termination condition is satisfied (OP109: YES), the process shown in FIG. 7 is terminated. When the termination condition is not satisfied (OP109: NO), the process proceeds to OP104, and the process in OP104 onwards is repeated.

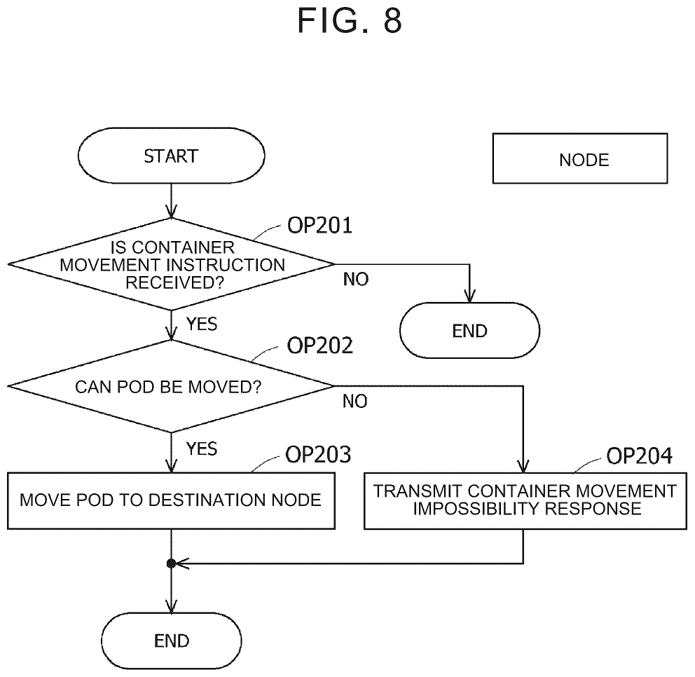

FIG. 8 shows an example of a flowchart of a process to be executed by the node 2 when a container movement instruction is received. The process shown in FIG. 8 is repeated, for example, at a predetermined cycle. Although the process shown in FIG. 8 is executed, for example, by the processor of the node 2, description will be given under the assumption that the process is executed by functional components for convenience.

In OP201, the control unit 21 determines whether a container movement instruction is received from the controller 1. When the container movement instruction is received from the controller 1 (OP201: YES), the process proceeds to OP202. For example, identification information, a maximum power consumption, and a power consumption of a destination node are received together with the container movement instruction. When the container movement instruction is not received from the controller 1 (OP201: NO), the process shown in FIG. 8 is terminated.

In OP202, the control unit 21 determines whether the deployed pod can be moved to the destination node. In the first embodiment, the determination in OP202 is affirmative when the sum of the power consumption of the destination node and the power consumption of the pod deployed in the node 2 is smaller than the maximum power consumption of the destination node. The determination in OP202 is negative when the sum of the power consumption of the destination node and the power consumption of the pod deployed in the node 2 is equal to or larger than the maximum power consumption of the destination node.

When the deployed pod can be moved to the destination node (OP202: YES), the process proceeds to OP203. In OP203, the control unit 21 moves the pod on the node 2 to the destination node. Then, the process shown in FIG. 8 is terminated.

When the deployed pod cannot be moved to the destination node (OP202: NO), the process proceeds to OP204. In OP204, the control unit 21 transmits a container movement impossibility response to the controller 1. Then, the process shown in FIG. 8 is terminated.

The process to be executed by the node 2 when the container movement instruction is received is not limited to the process shown in FIG. 8. For example, when the movement of the pod to the destination node is completed, the node 2 may notify the controller 1 about the completion of the container movement.

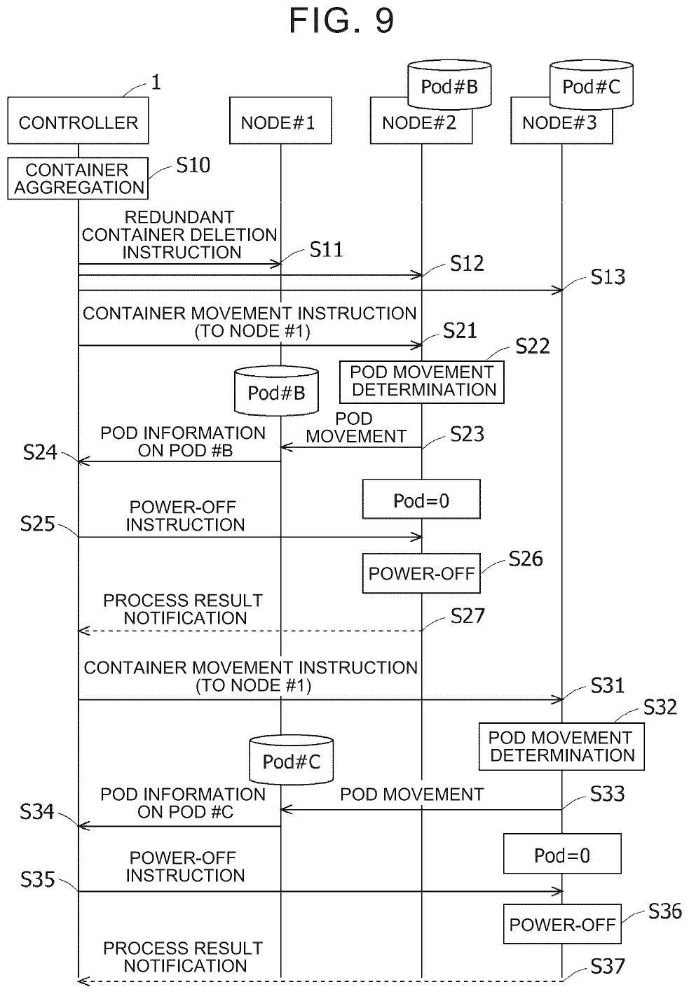

FIG. 9 shows an example of a sequence of the container aggregation process in the virtualization system 100. In FIG. 9, the virtualization system 100 includes nodes #1, #2, and #3. In S10, the controller 1 detects that the container aggregation condition is satisfied, and starts the container aggregation process (OP101 in FIG. 7: YES).

In S11, S12, and S13, the controller 1 transmits redundant container deletion instructions to nodes #1, #2, and #3 to delete redundant pods for applications (OP102 and OP103 in FIG. 7). When the redundant container deletion instruction is received, each of nodes #1, #2, and #3 deletes the corresponding pod. It is assumed that node #1 is a node where the largest number of pods are deployed after the process in S10 to S13. It is also assumed that pod #B is deployed in node #2 and pod #C is deployed in node #3.

In S21, the controller 1 determines node #2 as a source node and node #1 as a destination node (OP104 in FIG. 7), and transmits a container movement instruction to node #2. Identification information, a maximum power consumption, and a power consumption of node #1 that is the destination node are transmitted to node #2 together with the container movement instruction.

In S22, node #2 receives the container movement instruction from the controller 1 (OP201 in FIG. 8: YES), and determines to move pod #B to node #1 because the sum of the power consumption of node #1 and the power consumption of pod #B is smaller than the maximum power consumption of node #1 (OP202 in FIG. 8: YES). In S23, node #2 moves pod #B to node #1 (OP203 in FIG. 8).

In S24, node #1 starts periodically transmitting pod information on pod #B. By receiving the pod information on pod #B from node #1, the controller 1 detects completion of the movement of pod #B (OP106 in FIG. 7: YES). Through the movement of pod #B, node #2 has no pod deployed.

In S25, the controller 1 detects that node #2 has no pod deployed, and transmits a power-off instruction to node #2 (OP108 in FIG. 7). The controller 1 detects that node #2 has no pod deployed by, for example, referring to the pod information DB 13 and the node information DB 14.

In S26, node #2 receives the power-off instruction from the controller 1 and is powered off. In S27, node #2 notifies the controller 1 about the result of the power-off process. The result of the power-off process is transmitted immediately before node #2 is powered off.

In S31 to S37, the same process as that in S21 to S27 is executed with node #3 as the source node and node #1 as the destination node. In FIG. 9, it is assumed that the sum of the power consumption of node #1 and the power consumption of pod #C is smaller than the maximum power consumption of node #1 after pod #B is moved to node #1. Therefore, when the container movement instruction is transmitted from the controller 1 to node #3 (S31), pod #C is moved from node #3 to node #1 (S32, S33). Then, node #3 is powered off (S35 to S37).

In the example shown in FIG. 9, pods #B and #C are aggregated into node #1 and nodes #2 and #3 are powered off by the container aggregation process. Therefore, the power consumption caused by the operation of nodes #2 and #3 is reduced, and the power consumption of the entire virtualization system 100 can be reduced. Since pods #B and #C remain in the virtualization system 100, the respective application processes can be continued.

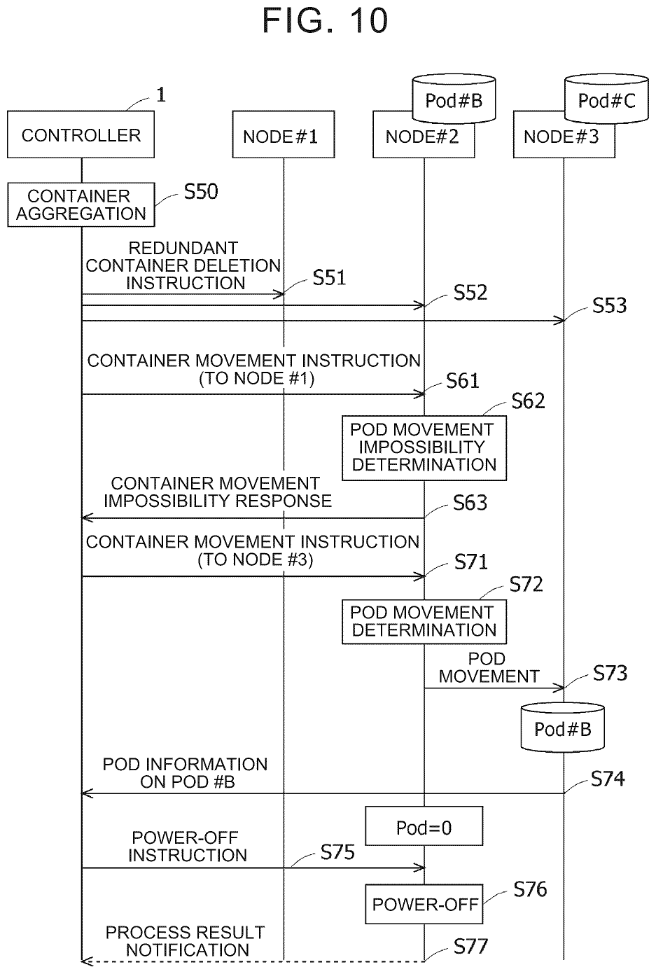

FIG. 10 shows an example of the sequence of the container aggregation process in the virtualization system 100. The configuration of the virtualization system 100 in FIG. 10 is similar to the configuration of the virtualization system 100 in FIGS. 9. S50 to S53 are similar to S10 to S13 in FIG. 9 in that the controller 1 starts the container aggregation process (S50) and transmits redundant container deletion instructions to nodes #1, #2, and #3 (S51 to S53) to delete the corresponding pods. The deployment of the pods after the process in S50 to S53 is similar to that shown in FIG. 9.

In S61, the controller 1 determines node #2 as a source node and node #1 as a destination node (OP104 in FIG. 7), and transmits a container movement instruction to node #2. Identification information, a maximum power consumption, and a power consumption of node #1 that is the destination node are transmitted to node #2 together with the container movement instruction.

In S62, node #2 receives the container movement instruction from the controller 1 (OP201 in FIG. 8: YES), and determines not to move pod #B to node #1 because the sum of the power consumption of node #1 and the power consumption of pod #B is equal to or larger than the maximum power consumption of node #1 (OP202 in FIG. 8: NO). In S63, the node #2 transmits a container movement impossibility response to the controller 1 (OP204 in FIG. 8).

In S71, the controller 1 receives the container movement impossibility response from node #2 (OP106 in FIG. 7: NO), and therefore selects node #3 as a new destination node and transmits a container movement instruction to node #2 (OP107 in FIG. 8). In S71, identification information, a maximum power consumption, and a power consumption of node #3 that is the new destination node are transmitted to node #2 together with the container movement instruction.

In S72, node #2 receives the container movement instruction from the controller 1 (OP201 in FIG. 8: YES), and determines to move pod #B to node #3 because the sum of the power consumption of node #3 and the power consumption of pod #B is smaller than the maximum power consumption of node #3 (OP202 in FIG. 8: YES). In S73, node #2 moves pod #B to node #3 (OP203 in FIG. 8).

In S74, node #3 starts periodically transmitting pod information on pod #B. By receiving the pod information on pod #B from node #3, the controller 1 detects completion of the movement of pod #B (OP106 in FIG. 7: YES). Through the movement of pod #B, node #2 has no pod deployed.

In S75, the controller 1 detects that node #2 has no pod deployed, and transmits a power-off instruction to node #2 (OP108 in FIG. 7). In S76, node #2 receives the power-off instruction from the controller 1 and is powered off. In S77, node #2 notifies the controller 1 about the result of the power-off process.

In the example shown in FIG. 10, pods #B and #C are aggregated into node #3 and node #2 is powered off by the container aggregation process. Therefore, the power consumption caused by the operation of node #2 is reduced, and the power consumption of the entire virtualization system 100 can be reduced.

In FIGS. 9 and 10, when a container aggregation process termination condition is satisfied, the control unit 11 may, for example, transmit a power-on instruction to the node 2 in the power-off state to operate the node 2. For example, when the virtualization system 100 is a communication network system, the container aggregation process termination condition is a time frame when the communication demand is equal to or higher than a threshold or a scheduled time of a global event coming even if the communication demand is lower than the threshold. The container aggregation process termination condition is not limited to this. Then, a new pod is added (scale-out) according to the processing demand on each pod in the virtualization system 100.

### Functions and Effects of First Embodiment

In the first embodiment, the pods operating in the virtualization system 100 are aggregated into part of the nodes 2 in response to a decrease in the processing demand. By powering off the node 2 where no pod is deployed, the power consumption of the entire virtualization system 100 can be reduced.

In the first embodiment, a node 2 where the largest number of pods are deployed is selected as the destination node. Thus, it is possible to reduce the number of pods to be moved, and to reduce the power consumption related to the movement of the pods.

### Modification of First Embodiment

In the first embodiment, in the container aggregation process, the controller 1 transmits the power-off instruction to the node 2 where no pod is deployed, and the node 2 that receives the power-off instruction powers off the machine. The present disclosure is not limited to this. In the container aggregation process, the controller 1 may transmit an instruction for transition to a power saving state to the node 2 where no pod is deployed, and the node 2 that receives the instruction for transition to the power saving state may make transition to the power saving state. Examples of the power saving state of the node 2 include “Power-off,” “Suspend,” and “Hibernate.” “Power-off” is a state in which the power supply to the node 2 is stopped. “Suspend” is a state in which the state of the node 2 is saved in the RAM (memory) and the power supply to devices other than the RAM is turned off. “Hibernate” is a state in which the state of the node 2 is saved in the hard disk drive and the power supply to the node 2 is turned off. In the process of transition to the power saving state, the administrator of the virtualization system 100 can set the state of the node 2 to “Power-off,” “Suspend,” or “Hibernate” as desired.

In the first embodiment, the container aggregation process is executed by aggregating pods on a node-by-node basis and powering off a node 2 where no pod is deployed. The container aggregation process may be executed, for example, on a rack-by-rack or floor-by-floor basis. More specifically, pods may be aggregated into a plurality of nodes stacked on one rack, and all nodes stacked on another rack where none of the stacked nodes has a pod deployed may be powered off. In this case, the nodes may be managed on a rack-by-rack or floor-by-floor basis.

In the first embodiment, the source node determines whether to move the pod to the destination node, but the present disclosure is not limited to this, and the controller 1 may execute the determination. For example, the node 2 transmits the power consumption of each deployed container to the controller 1 as a piece of the pod information, and the controller 1 can determine whether to move the pod from the source node to the destination node. When the controller 1 determines that the pod can be moved from the source node to the destination node, the controller 1 may transmit the container movement instruction to the source node.

### Application Example

The virtualization system 100 of the first embodiment can be applied to, for example, a 5G core network system. In this case, the pod is an instance of any network function (NF) in the 5G core network, such as an access and mobility management function (AMF), a session management function (SMF), a user plane function (UPF), or an edge application server (EAS).

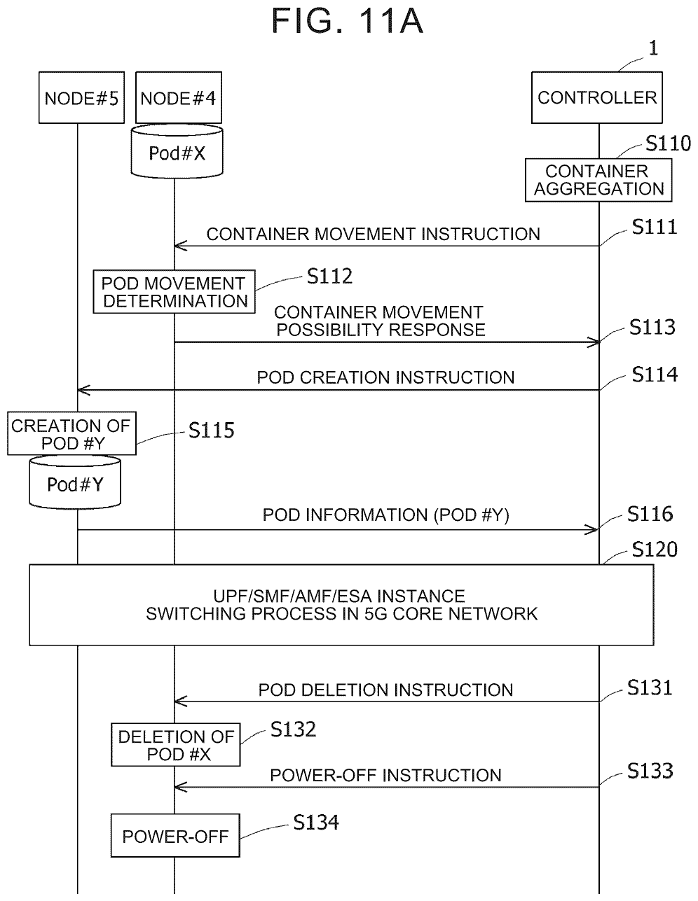

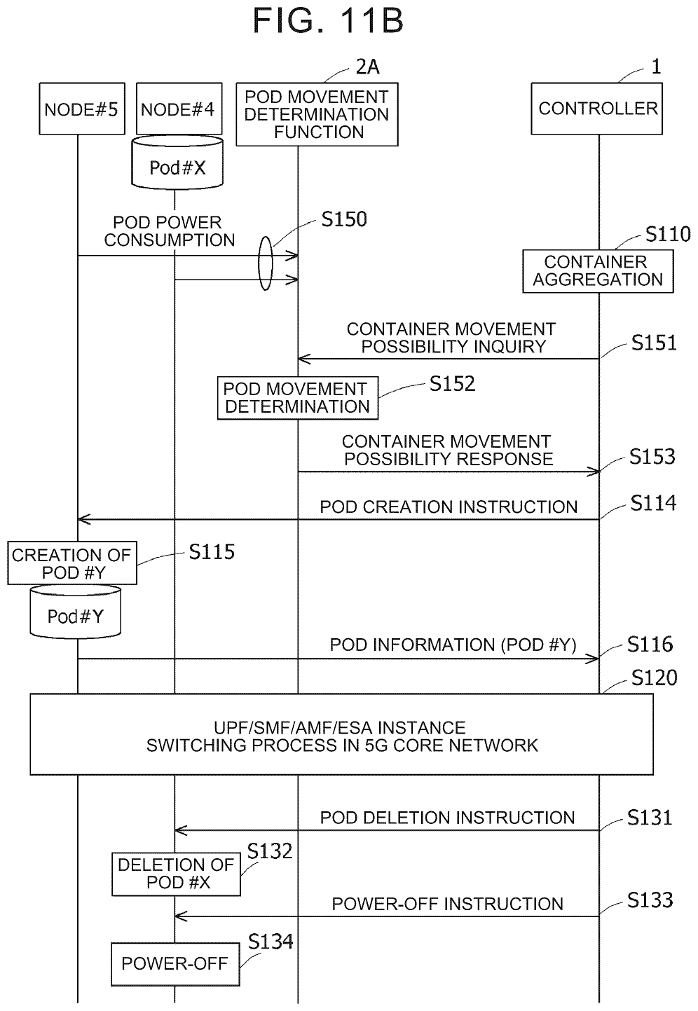

FIG. 11A shows an example of a sequence of the container aggregation process when the virtualization system 100 is applied to the 5G core network system. When the virtualization system 100 is applied to a communication system, for example, the following procedure is adopted instead of moving a pod to avoid communication interruptions. A copy of the pod is created in the destination node and then the pod in the source node is deleted. Therefore, the node 2 receives a container movement instruction from the controller 1 (OP201 in FIG. 8), determines whether the pod can be moved to the destination node (OP202 in FIG. 8), and then, unlike the process described in FIG. 8, transmits the result of the determination as to whether the pod can be moved to the destination node as a response to the controller 1.

In the example shown in FIG. 11A, the virtualization system 100 includes nodes #4 and #5. In the example shown in FIG. 11A, the controller 1 and nodes #4 and #5 are also devices in the 5G core network system. In the example shown in FIG. 11A, it is assumed that pod #X that is an instance of any NF is operating on node #4.

In S110, the controller 1 detects that the container aggregation condition is satisfied, and starts the container aggregation process. In S111, the controller 1 determines node #4 as a source node and node #5 as a destination node, and transmits a container movement instruction to node #4. Identification information, a maximum power consumption, and a power consumption of node #5 that is the destination node and identification information of a pod to be moved are transmitted to node #4 together with the container movement instruction. In the example shown in FIG. 11A, when there is an idle redundant pod, the controller 1 transmits an instruction to delete the idle pod to the corresponding node 2 before the process in S111.

In S112, node #4 receives the container movement instruction from the controller 1, and determines to move pod #X to node #5 because the sum of the power consumption of node #5 and the power consumption of pod #X is smaller than the maximum power consumption of node #5. In S113, node #4 transmits, to the controller 1, a container movement possibility response indicating that pod #X can be moved to node #5.

In S114, the controller 1 transmits, to node #5, a pod creation instruction for creation of a pod of the same type of instance as that of pod #X. In S115, node #5 receives the pod creation instruction from the controller 1, and creates pod #Y of the same type of instance as that of pod #X. In S116, node #5 starts periodically transmitting pod information on pod #Y. Thus, the controller 1 detects that pod #Y is added.

In S120, an instance switching process is executed in the 5G core network. The process in S120 differs depending on the type of NF instance. The details of the process in S120 will be described later for examples in which the instance to be switched is a UPF, an SMF, and an AMF.

In S131, the controller 1 detects that the switching of the instance in the 5G core network is completed, and transmits an instruction to delete pod #X to node #4. In S132, node #4 deletes pod #X. When pod #X is deleted, the pod information on pod #X is no longer received by the controller 1, and thus the controller 1 can detect that pod #X is deleted.

In S133, the controller 1 detects that node #4 has no pod deployed, and transmits a power-off instruction to node #4. In S134, node #4 receives the power-off instruction from the controller 1 and is powered off. In FIG. 11A, the procedure is adopted in which the copy of the target pod is created in the destination node and then the target pod in the source node is deleted, but the procedure is not limited to this. For example, when a pod of the same type as that of the target pod is deployed in the destination node, the target pod may be merged with the pod deployed in the destination node.

FIG. 11B shows another example of the sequence of the container aggregation process when the virtualization system 100 is applied to the 5G core network system. In FIG. 11B, a pod movement determination function 2A that executes a process of determining whether a pod can be moved from a source node to a destination node is introduced into the 5G core network as an additional function of a new NF or an existing NF. Example of the NF to which the pod movement determination function 2A is added as a new function include a network data analytics function (NWDAF). The NF to which the pod movement determination function 2A can be added is not limited to the NWDAF. The pod movement determination function 2A may determine whether a pod can be moved from a source node to a destination node using logic similar to that for the node 2 in the first embodiment. In FIG. 11B, the same processes as those in FIG. 11A are denoted by the same signs.

When the pod movement determination function 2A is introduced as shown in FIG. 11B, the pod movement determination function 2A periodically collects, from each node 2, the power consumption of the node 2 and the power consumption of each pod deployed in the node 2 (S150). The pod movement determination function 2A also acquires the maximum power consumption of each node 2 through notification from each node 2.

When the controller 1 detects that the container aggregation condition is satisfied, the controller 1 starts the container aggregation process (S110). In S151, the controller 1 determines node #4 as a source node and node #5 as a destination node, and transmits a container movement possibility inquiry to the pod movement determination function 2A to inquire whether pod #X can be moved from source node #4 to destination node #5. Identification information of node #4 that is the source node, identification information of node #5 that is the destination node, and identification information of pod #X to be moved are transmitted together with the container movement possibility inquiry.

In S152, the pod movement determination function 2A receives the container movement possibility inquiry from the controller 1, and determines that pod #X can be moved to node #5 because the sum of the power consumption of node #5 and the power consumption of pod #X is smaller than the maximum power consumption of node #5. In S153, the pod movement determination function 2A transmits, to the controller 1, a container movement possibility response indicating that pod #X can be moved from node #4 to node #5. When determination is made that the pod cannot be moved from the source node to the destination node, the pod movement determination function 2A transmits a container movement impossibility response to the controller 1.

The process in S114 onwards is the same as that in FIG. 11A. The controller transmits a pod creation instruction to node #5 (S114). Node #5 creates pod #Y (S115), and the instance switching process from pod #X to pod #Y is executed (S120).

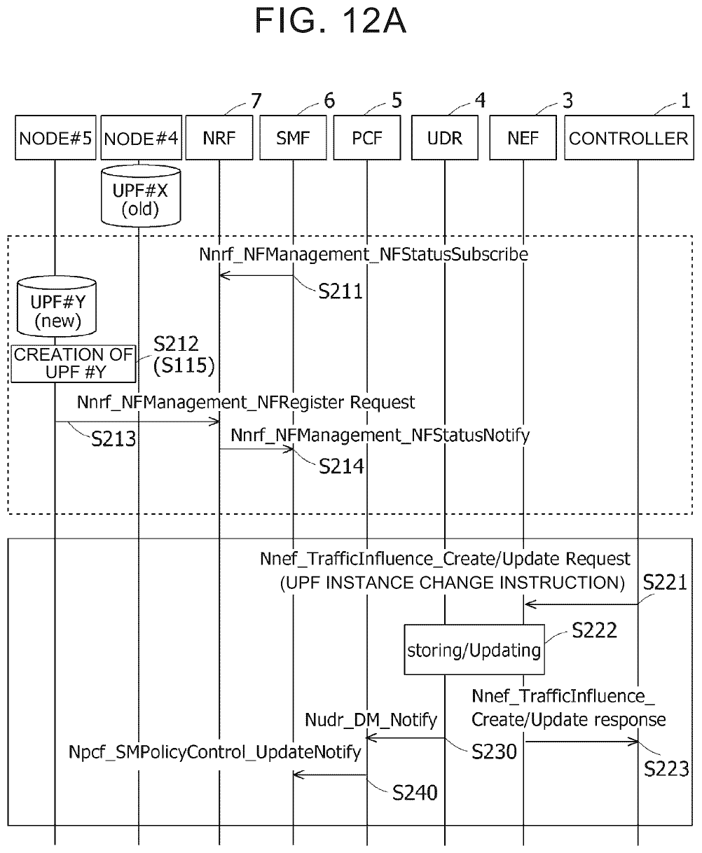

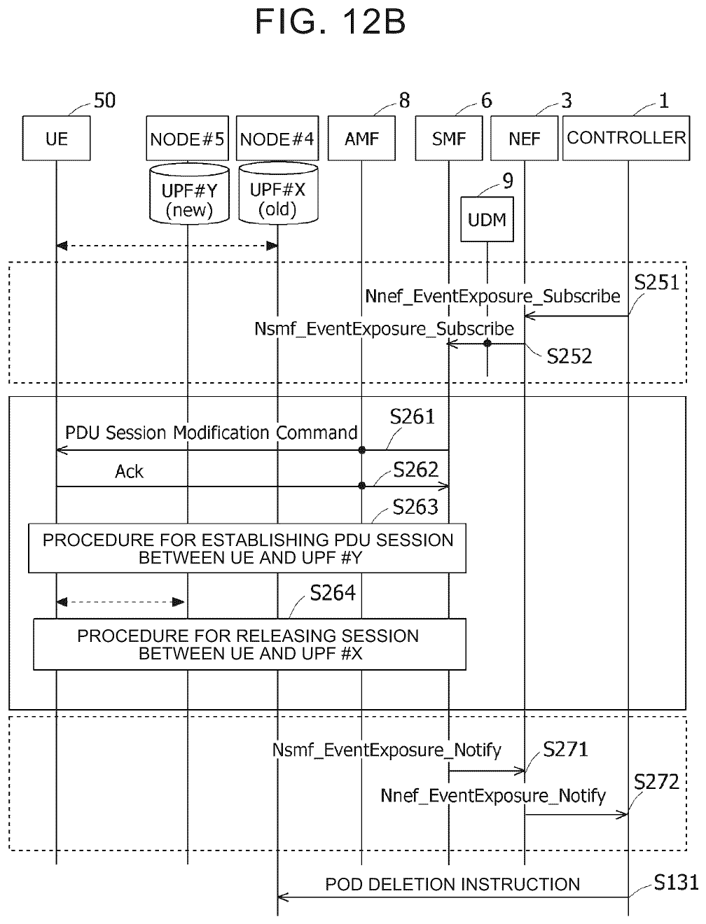

FIGS. 12A and 12B show an example of a sequence of the instance switching process in the 5G core network when a pod is an instance of a UPF. The process shown in FIGS. 12A and 12B corresponds to the process executed in S120 in FIGS. 11A and 11B when the pod is an instance of the UPF.

In S211, an SMF 6 transmits an Nnrf_NFManagement_NFStatusSubscribe message to a network repository function (NRF) 7. The Nnrf_NFManagement_NFStatusSubscribe message transmitted in S211 is a message for requesting registration in the NRF 7 so that notification is made about a network function (NF) instance newly added to the 5G core network. The process in S211 may be executed in advance prior to the container aggregation process.

In S212, node #5 creates UPF #Y (pod #Y) that is a new UPF instance in response to reception of the pod creation instruction from the controller 1 (S114). The process in S212 corresponds to the process in S115 in FIGS. 11A and 11B. In S213, UPF #Y transmits an Nnrf_NFManagement_NFRegisterRequest message to the NRF 7. The Nnrf_NFManagement_NFRegisterRequest message transmitted in S213 is a message for requesting registration of instance information on UPF #Y in the NRF 7.

In S214, the NRF 7 transmits an Nnrf_NFManagement_NFStatusNotify message to the SMF 6 because UPF #Y is newly added. The Nnrf_NFManagement_NFStatusNotify message transmitted in S214 is a message for notifying the SMF 6 that UPF #Y is newly added. Thus, the SMF 6 can recognize the presence of UPF #Y and, for example, when a packet data unit (PDU) session establishment request is made, can select UPF #Y as a UPF to be used for the PDU session.

The process in S221 onwards is a process for switching the UPF instance from UPF #X to UPF #Y. When switching the UPF instance, user equipment (UE) that has connected to UPF #X and established a PDU session needs to reconnect to UPF #Y and re-establish the PDU session.

In S221, the controller 1 transmits an Nnef_TrafficInfluence_Create (or Update) request message to a network exposure function (NEF) 3. The Nnef_TrafficInfluence_Create (or Update) message transmitted in S221 is an instruction message for change of the PDU session. In the first embodiment, the Nnef_TrafficInfluence_Create (or Update) request message corresponds to a UPF instance switching instruction for switching of the UPF instance. For example, information on UPF #X that is the source of movement of the PDU session and UPF #Y that is the destination of the movement and policy information are transmitted together with the Nnef_TrafficInfluence_Create (or Update) request message. The information on UPF #X that is the source of movement of the PDU session and UPF #Y that is the destination of the movement includes, for example, identification information of the UPF instance. The policy information includes, for example, an instruction to move the PDU session on UPF #X to UPF #Y. For example, a list of data network names (DNNs) and data network access identifiers (DNAIs) of data networks that are destinations of traffic handled by UPF #X is also transmitted together with the Nnef_TrafficInfluence_Create (or Update) request message. For example, when the UPF instance is switched from UPF #X to UPF #Y, a new destination for handling the traffic that is currently handled by UPF #X may be determined without being limited to UPF #Y. In such a case, a UPF that will be the new destination for handling the traffic that is currently handled by UPF #X may be determined based on the DNN and the DNAI. The Nnef_TrafficInfluence_Create (or Update) request message in S221 is an example of a “second request.”

In S222, the NEF 3 stores the policy information received together with the Nnef_TrafficInfluence_Create (or Update) request message in a unified data repository (UDR) 4. In S223, the NEF 3 transmits an Nnef_TrafficInfluence_Create (or Update) response message to the controller 1.

In S230, the UDR 4 transmits, to a policy control function (PCF) 5, an Nudr_DM_Notify message for notification that the policy information is changed. The policy information is transmitted together with the Nudr_DM_Notify message.

In S240, the PCF 5 transmits, to the SMF 6, an Npcf_SMPolicyControl_UpdateNotify message for providing an update on the policy information applied to the PDU session. The policy information is transmitted together with the Npcf_SMPolicyControl_UpdateNotify message.

In S251 in FIG. 12B, the controller 1 transmits, to the NEF 3, an Nnef_EventExposure_Subscribe request message for requesting notification of the occurrence of an event related to a specified NF. An instruction to monitor establishment and release of the PDU session is transmitted together with the Nnef_EventExposure_Subscribe request message transmitted in S251.

In S252, when the Nnef_EventExposure_Subscribe request message is received, the NEF 3 converts it into an Nudm_EventExposure_Subscribe request message and transmits it to a unified data management (UDM) 9. When the Nudm_EventExposure_Subscribe request message is received, the UDM 9 converts it into an Nsmf_EventExposure_Subscribe request message and transmits it to the SMF 6. Thus, the SMF 6 notifies the NEF 3 when the PDU session is established or released.

In S261, the SMF 6 receives the Npcf_SMPolicyControl_UpdateNotify message from the PCF 5 (S240), and transmits a PDU Session Modification Command to UE 50 via an AMF 8 according to the policy information including an instruction to move the PDU session on UPF #X to UPF #Y. The PDU Session Modification Command transmitted in S261 instructs the UE 50 to release the PDU session with UPF #X and establish a PDU session with UPF #Y. In S262, the UE 50 transmits an acknowledgement to the PDU Session Modification Command to the SMF 6 via the AMF 8.

In S263, a procedure for establishing the PDU session between the UE 50 and UPF #Y is executed (see, for example, 4.3.2.2.1 of 3GPP TS 23.502). In S264, a procedure for releasing the PDU session between the UE 50 and UPF #X is executed (see, for example, 4.3.4.2 of 3GPP TS 23.502).

In S271, the SMF 6 transmits an Nsmf_EventExposure_Notify message to the NEF 3 for notification about the establishment of the PDU session in S263 and the release of the PDU session in S264. In S272, when the Nsmf_EventExposure_Notify message is received, the NEF 3 converts it into an Nnef_EventExposure_Notify message and transmits it to the controller 1. By receiving the Nnef_EventExposure_Notify message, the controller 1 detects the release of the PDU session on UPF #X and the establishment of the PDU session on UPF #Y, that is, the completion of the switching of the UPF instance. Then, a pod deletion instruction for pod #X that corresponds to S131 in FIGS. 11A and 11B is transmitted from the controller 1 to node #4. In FIGS. 12A and 12B, some of the response messages to the reception of the request messages are omitted. In FIGS. 12A and 12B, UPF #X is an example of an “old first NF instance” and UPF #Y is an example of a “new first NF instance.” The NEF 3 is an example of a “second NF instance.”

In the process sequence shown in FIGS. 12A and 12B, a PDU session in Session and Service Continuity (SSC) mode 3 is assumed. The PDU session is not limited to this, and may be a PDU session in SSC mode 1 or 2. When the PDU session is a PDU session in SSC mode 1 or 2, for example, the following process sequence may be executed instead of the process sequence of switching the UPF instance in S261 to S264.

When the Npcf_SMPolicyControl_UpdateNotify message is received from the PCF 5 in S240, the SMF 6 first deletes the instance information of UPF #X from the NRF 7 in accordance with the policy information including an instruction to move the PDU session on UPF #X to UPF #Y. For example, the SMF 6 deletes the instance information of UPF #X from the NRF 7 by transmitting an Nnrf_NFManagement_NFDeregister request message to the NRF 7. This suppresses assignment of a new PDU session to UPF #X.

Next, the SMF 6 waits for completion of communication of the PDU session on UPF #X. When the communication of the PDU session is completed, the SMF 6 transmits a PDU Session Release Command message to the UE 50 via the AMF 8 to instruct the UE 50 to release the PDU session on UPF #X. When the PDU Session Release Command message is received, a PDU session release procedure is executed between the UE 50 and UPF #X (see, for example, 4.3.4.2 of 3GPP TS 23.502). When the UE 50 starts a new PDU session communication, UPF #Y or another UPF is selected and a new PDU session is assigned.

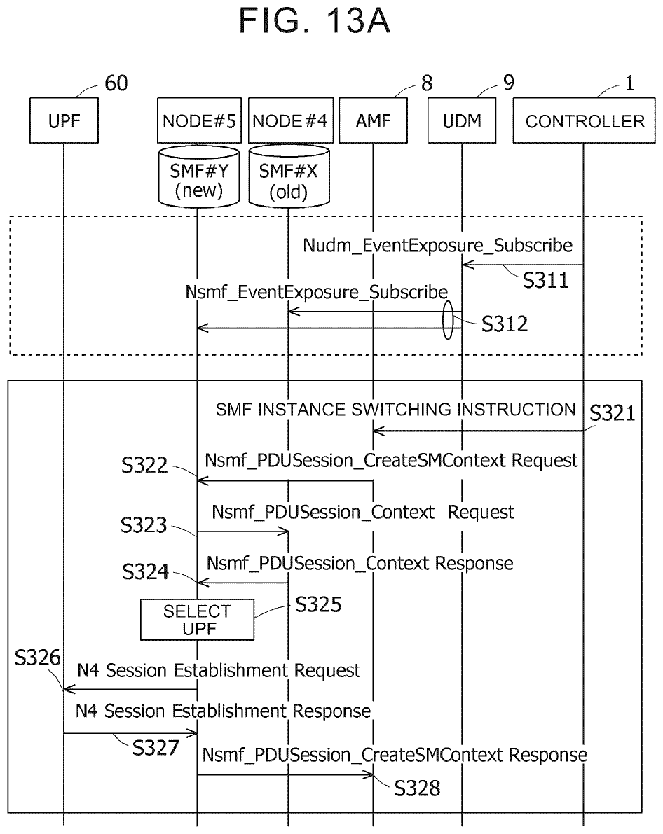

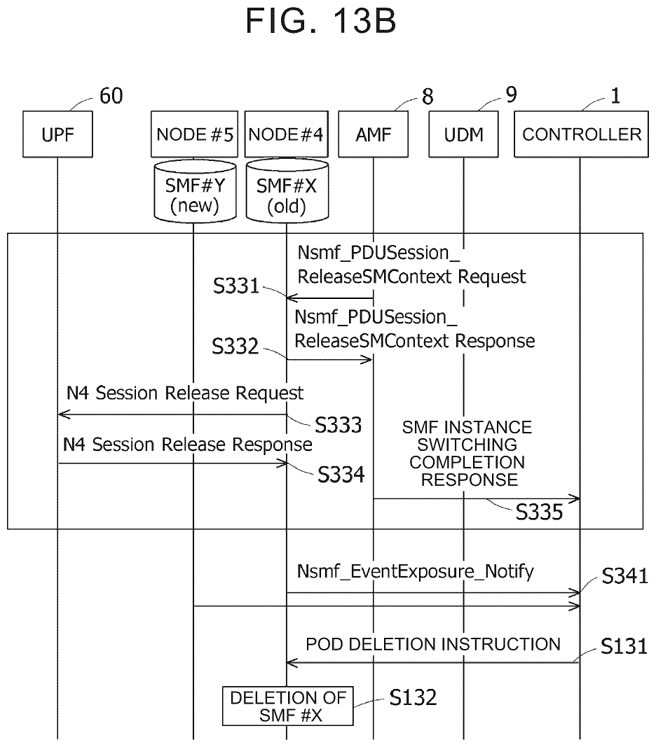

FIGS. 13A and 13B show an example of a sequence of the instance switching process in the 5G core network when a pod is an instance of an SMF. The process shown in FIGS. 13A and 13B corresponds to the process executed in S120 in FIGS. 11A and 11B when the pod is an instance of the SMF. Therefore, in FIGS. 13A and 13B, old pod #X is SMF #X and new pod #Y is SMF #Y. When switching the SMF instance, the controller 1 operates as one of the NFs in the 5G core network.

In S311, the controller 1 transmits an Nudm_EventExposure_Subscribe request message to the UDM 9. An instruction to monitor a management trend on the PDU session is transmitted together with the Nudm_EventExposure_Subscribe request message.

In S312, when the Nudm_EventExposure_Subscribe request message is received, the UDM 9 converts it into an Nsmf_EventExposure_Subscribe request message and transmits it to, for example, SMF #X and SMF #Y. Therefore, SMF #X and SMF #Y notify the NEF 3 when they are newly associated with the PDU session or when they are released from association with the PDU session. In S311, the controller 1 may also transmit identification information of SMF #X and SMF #Y together with the Nudm_EventExposure_Subscribe request message to specify the SMFs to be monitored.

In S321, the controller 1 transmits an SMF instance switching instruction to the AMF 8. When there is a plurality of AMFs 8, the SMF instance switching instruction is transmitted to the AMF that manages the UE associated with the PDU session managed by SMF #X. The AMF that manages the UE associated with the PDU session managed by SMF #X can be acquired, for example, by inquiring of the UDM. For example, information indicating that the switching is from SMF #X to SMF #Y and the identification information of SMF #X and SMF #Y are transmitted together with the SMF instance switching instruction. The SMF instance switching instruction in S321 is an example of the “second request.”

In S322, when the SMF instance switching instruction is received, the AMF 8 transmits an Nsmf_PDUSession_CreateSMContext request message to SMF #Y to request creation of association between the AMF 8 and SMF #Y that manage the same PDU session. The association among the PDU session, the AMF, and the SMF is included in an SM context. The SM context is setting information for managing the PDU session. The Nsmf_PDUSession_CreateSMContext request message is a message for requesting creation of the SM context.

For example, identification information of the AMF 8, identification information of the PDU session (PDU session ID) associated with the AMF 8 and SMF #X, and identification information of the SM context (SM context ID) including the association between the AMF 8 and SMF #X are transmitted together with the Nsmf_PDUSession_CreateSMContext request message. The SM context including the association between the AMF 8 and SMF #X also includes the PDU session ID of the PDU session associated with the AMF 8 and SMF #X. The PDU session associated with the AMF 8 and SMF #X is a PDU session whose management is handed over from SMF #X to SMF #Y. Hereinafter, the PDU session whose management is handed over from SMF #X to SMF #Y is referred to as “PDU session to be handed over.” That is, the SM context ID transmitted together with the Nsmf_PDUSession_CreateSMContext request message is identification information of the context related to the PDU session to be handed over.

In S323, SMF #Y transmits an Nsmf_PDUSession_Context request message to SMF #X to request provision of the SM context. For example, the context ID of the SM context related to the PDU session to be handed over is transmitted together with the Nsmf_PDUSession_Context request message. In S324, SMF #X receives the Nsmf_PDUSession_Context request message and, in response, transmits, to SMF #Y, an Nsmf_PDUSession_Context response message and the SM context related to the PDU session to be handed over.

In S325, SMF #Y selects a UPF 60 responsible for managing the PDU session to be handed over based on the SM context received in S324. For example, the SM context received in S324 includes single-network slice selection assistance information (S-NSSAI) and UE location information as information for identifying the UPF 60 responsible for managing the PDU session to be handed over.

In S326, SMF #Y transmits an N4 Session Establishment request message to the UPF 60 to request establishment of an N4 session. In S327, the UPF 60 establishes the N4 session with SMF #Y, and transmits an N4 Session Establishment response message to SMF #Y. When the process in S327 is completed, SMF #Y creates and registers an SM context including association among the AMF 8, SMF #Y, and the PDU session to be handed over.

In S328, SMF #Y transmits an Nsmf_PDUSession_CreateSMContext response message to the AMF 8 in response to the Nsmf_PDUSession_CreateSMContext request message received in S322.

In S331 in FIG. 13B, the AMF 8 transmits an Nsmf_PDUSession_ReleaseSMContext request message to SMF #X to request deletion of the SM context related to the PDU session to be handed over. In S332, when the Nsmf_PDUSession_ReleaseSMContext request message is received, SMF #X deletes the SM context related to the PDU session to be handed over, and transmits an Nsmf_PDUSession_ReleaseSMContext response message to the AMF 8.

In S333, SMF #X transmits an N4 Session Release request message to the UPF 60 to request release of the N4 session. In S334, the UPF 60 releases the N4 session with SMF #X, and transmits an N4 Session Release response message to SMF #X. In S335, the AMF 8 transmits an SMF instance switching completion response to the controller 1.

In S341, SMF #Y transmits an Nsmf_EventExposure_Notify message to the controller 1 for notification that it is newly responsible for the management of the PDU session through the process in S322 to S328 (new SM context is registered), and SMF #X transmits an Nsmf_EventExposure_Notify message to the controller 1 for notification that it is released from the responsibility for the process of the PDU session through the process in S331 to S334 (SM context is deleted). By receiving the Nsmf_EventExposure_Notify messages, the controller 1 detects that the process of the PDU session is handed over from SMF #X to SMF #Y. Then, a pod deletion instruction for pod #X that corresponds to S131 in FIGS. 11A and 11B is transmitted from the controller 1 to node #4. In S132, SMF #X is deleted by node #4. In FIGS. 13A and 13B, some of the response messages to the reception of the request messages are omitted.

At least either of the process in S311 to S312 and S341 for notifying the controller that the SMF instance switching is completed in the 5G core network and the process of transmitting the SMF instance switching completion response in S335 may be executed. In FIGS. 13A and 13B, SMF #X is an example of the “old first NF instance” and SMF #Y is an example of the “new first NF instance.” The AMF 8 is an example of the “second NF instance.”

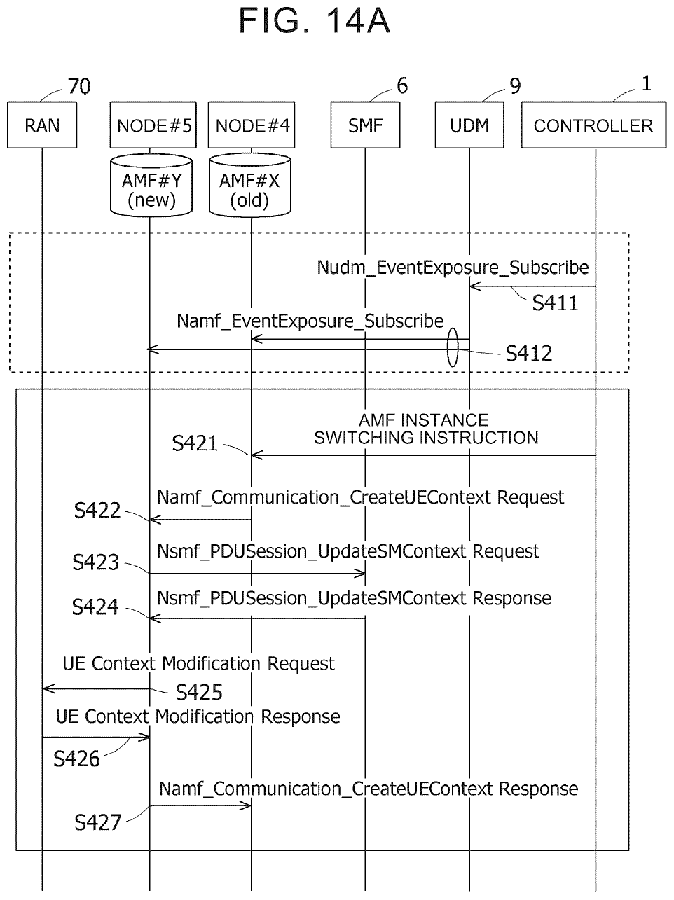

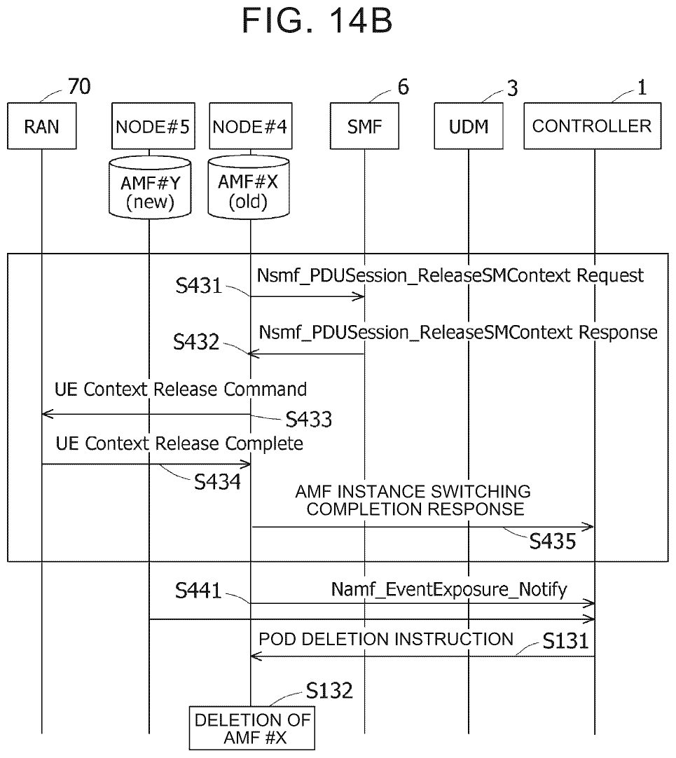

FIGS. 14A and 14B show an example of a sequence of the instance switching process in the 5G core network when a pod is an instance of an AMF. The process shown in FIGS. 14A and 14B corresponds to the process executed in S120 in FIGS. 11A and 11B when the pod is an instance of the AMF. Therefore, in FIGS. 14A and 14B, old pod #X is AMF #X and new pod #Y is AMF #Y. When switching the AMF instance, the controller 1 operates as one of the NFs in the 5G core network.

In S411, the controller 1 transmits an Nudm_EventExposure_Subscribe request message to the UDM 9. An instruction to monitor a mobility event is transmitted together with the Nudm_EventExposure_Subscribe request message transmitted in S411.

In S412, when the Nudm_EventExposure_Subscribe request message is received, the UDM 9 converts it into an Namf_EventExposure_Subscribe request message and transmits it to AMF #X and AMF #Y. Therefore, AMF #X and AMF #Y notify the NEF 3 when they are newly responsible for the management of the PDU session or when they are released from the responsibility for the management of the PDU session. In S411, the controller 1 may also transmit identification information of AMF #X and AMF #Y together with the Nudm_EventExposure_Subscribe request message to specify the AMFs to be monitored.

In S421, the controller 1 transmits an AMF instance switching instruction to the AMF #X. For example, information indicating that the switching is from AMF #X to AMF #Y and the identification information of AMF #Y are transmitted together with the AMF instance switching instruction. The AMF instance switching instruction in S421 is an example of the “second request.”

In S422, when the AMF instance switching instruction is received, AMF #X transmits an Namf_Communication_CreateUEContext request message to AMF #Y to request new AMF #Y to take over a UE context. The association among the AMF, the UE, and the PDU session is included in the UE context. A UE context related to the PDU session that is currently managed by AMF #X and will be handed over to AMF #Y is transmitted together with the Namf_Communication_CreateUEContext request message. Hereinafter, the PDU session that is currently managed by AMF #X and will be handed over to AMF #Y is referred to as “PDU session to be handed over.”

In S423, AMF #Y transmits an Nsmf_PDUSession_UpdateSMContext request message to the SMF 6 to request an update of the SM context to change the AMF associated with the PDU session to be handed over to AMF #Y. Identification information of AMF #Y and a PDU session ID to be handed over are transmitted together with the Nsmf_PDUSession_UpdateSMContext request message. In S424, when the Nsmf_PDUSession_UpdateSMContext request message is received from AMF #Y, the SMF 6 updates the SM context by associating AMF #Y with the PDU session to be handed over, and transmits an Nsmf_PDUSession_UpdateSMContext response message to AMF #Y.

In S425, AMF #Y transmits a UE Context Modification Request message to a radio access network (RAN) 70 to request registration of the UE context. The UE context related to the PDU session to be handed over is transmitted together with the UE Context Modification Request message. In S426, when the UE Context Modification Request message is received, the RAN 70 registers the UE context related to the PDU session to be handed over, and transmits a UE Context Modification Response message to AMF #Y.

In S427, AMF #Y transmits a Namf_Communication_CreateUEContext response message to AMF #X. Through the process in S422 to S427, the setting for newly created AMF #Y to take over the PDU session from AMF #X is completed.

In S431 in FIG. 14B, AMF #X transmits an Nsmf_PDUSession_ReleaseSMContext request message to the SMF 6 to request deletion of the SM context related to the PDU session to be handed over. In S432, the SMF 6 deletes the SM context related to the PDU session to be handed over, and transmits an Nsmf_PDUSession_ReleaseSMContext response message to AMF #X.

In S433, AMF #X transmits a UE Context Release Command message to the RAN 70 to request deletion of the UE context related to the PDU session to be handed over. In S434, the RAN 70 deletes the UE context related to the PDU session to be handed over, and transmits a UE Context Release Complete message to AMF #X. When the UE Context Release Complete message is received, AMF #X deletes the UE context related to the PDU session to be handed over.

Through the process in S431 to S434, the setting of the PDU session to be handed over is deleted from old AMF #X, and then the process of the PDU session to be handed over is executed by AMF #Y. In S435, AMF #X transmits an AMF instance switching completion response to the controller 1.

In S441, AMF #Y transmits an Namf_EventExposure_Notify message to the controller 1 for notification that it is newly responsible for the process of the PDU session through the process in S422 to S427 (new UE context is registered), and AMF #X transmits an Namf_EventExposure_Notify message to the controller 1 for notification that it is released from the responsibility for the process of the PDU session through the process in S431 to S434 (UE context is deleted). By receiving the Namf_EventExposure_Notify messages, the controller 1 detects that the process of the PDU session is handed over from AMF #X to AMF #Y. Then, a pod deletion instruction for pod #X that corresponds to S131 in FIGS. 11A and 11B is transmitted from the controller 1 to node #4. In S132, AMF #X is deleted by node #4. In FIGS. 14A and 14B, some of the response messages to the reception of the request messages are omitted.

At least either of the process in S411 to S412 and S441 for notifying the controller that the AMF instance switching is completed in the 5G core network and the process of transmitting the AMF instance switching completion response in S435 may be executed. In FIGS. 14A and 14B, AMF #X is an example of the “old first NF instance” and AMF #Y is an example of the “new first NF instance.” AMF #X is an example of the “second NF instance.”

According to FIGS. 11A to 14B, the pod aggregation process can be executed without stopping the process of the NF in the 5G core network, that is, without interrupting the communication of the UE, and the power consumption of the virtualization system 100 can be reduced.

In FIGS. 12A, 12B, 13A, 13B, 14A, and 14B, the process between the controller 1 and each NF (e.g., S221, S223, S251, S272, S311, S321, S335, S341, S441, S435, S441) may be executed by an NF in the 5G core network other than the controller 1 in cooperation with the controller 1. In this case, the NF in the 5G core network other than the controller 1 is an example of the “second NF instance.”

The switching of the NF instance can also be applied to switching of edge application servers (EAS) in an edge computing system such as multi-access edge computing (MEC). For example, after detection of addition of new pod #Y (EAS instance) in S116 in FIGS. 11A and 11B, the controller 1 may execute switching of the EAS instance by transmitting an Nnef_TrafficInfluence_Create/Update message to the NEF to instruct the NEF to switch the EAS instance.

### Other Embodiments

The above embodiments are merely illustrative, and the present disclosure may be modified as appropriate without departing from the spirit and scope of the present disclosure.

The processes and means described in the present disclosure can be combined as desired as long as no technical contradiction occurs.

The process described as being executed by a single device may be executed by a plurality of devices in cooperation. Alternatively, the process described as being executed by different devices may be executed by a single device. In a computer system, the hardware configuration (server configuration) that implements functions can be changed flexibly.

The present disclosure may be embodied such that a computer program that implements the functions described in the above embodiments is supplied to a computer and is read and executed by one or more processors of the computer. The computer program may be provided to the computer by being stored in a non-transitory computer-readable storage medium connectable to a system bus of the computer, or may be provided to the computer via a network. Examples of the non-transitory computer-readable storage medium include any type of disk or disc such as a magnetic disk (floppy (registered trademark) disk, hard disk drive (HDD), etc.) and an optical disc (compact disc (CD) ROM, digital versatile disc (DVD), Blu-ray disc, etc.), a read only memory (ROM), a random access memory (RAM), an EPROM, an electrically erasable programmable ROM (EEPROM), a magnetic card, a flash memory, an optical card, and any type of medium suitable for storing electronic instructions.

What is claimed is:

1. A system comprising:
a plurality of nodes in each of which at least one container is deployed; and
an information processing device including a control unit, wherein
the control unit is configured to:
transmit, to a first node out of the plurality of nodes, a first request for instruction to move one or more containers deployed in the first node to a second node out of the plurality of nodes; and
transmit an instruction for transition to a power saving state to the first node when no container is present on the first node.

2. The system according to claim 1, wherein
the control unit is configured to:
transmit the first request to a plurality of the first nodes; and
transmit the instruction for transition to the power saving state to the first nodes when no container is present on each of the first nodes.

3. The system according to claim 1, wherein the control unit is further configured to determine, as the second node, a node included in a predetermined number of top nodes where a larger number of containers are deployed out of the plurality of nodes.

4. The system according to claim 1, wherein
the control unit is configured to:
when the one or more containers deployed in the first node are not movable to the second node, determine, as a new second node, a node included in a predetermined number of top nodes where a larger number of containers are deployed out of the plurality of nodes; and
transmit, to the first node, the first request for instruction to move the one or more containers deployed in the first node to the new second node.

5. The system according to claim 1, wherein
each of the nodes is configured to:
when the first request is received from the information processing device, determine whether to execute movement of the one or more containers to the second node;
when determination is made to execute the movement of the one or more containers to the second node, execute a process related to the movement of the one or more containers to the second node; and
when determination is made not to execute the movement of the one or more containers to the second node, notify the information processing device that the movement of the one or more containers to the second node is not to be executed.

6. The system according to claim 5, wherein
each of the nodes is configured to:
monitor a power consumption of the one or more deployed containers; and
when the first request is received, determine whether to execute the movement of the one or more containers to the second node based on the power consumption of the one or more containers and a maximum power consumption and a current power consumption of the second node.

7. The system according to claim 1, wherein the control unit is configured to determine the first node among the plurality of nodes based on the number of deployed containers.

8. The system according to claim 1, wherein the control unit is further configured to, when a group of a plurality of first containers configured to execute the same service is present among the nodes, transmit, before transmitting the first request, a second request for instruction to delete the first container to one or more nodes where one or more remaining first containers other than one first container in the group are deployed.

9. The system according to claim 1, wherein the container is any function in a core network of a mobile communication network.

10. The system according to claim 1, wherein the container is an instance of any network function in a core network of a fifth-generation mobile communication network.

11. The system according to claim 10, wherein
the control unit is further configured to:
when the container is newly deployed in the second node as a new first network function instance after the first request is transmitted, transmit, to a second network function instance, a second request for instruction for switching from an old first network function instance deployed in the first node to the new first network function instance deployed in the second node; and
when the switching from the old first network function instance to the new first network function instance is completed, transmit an instruction to delete the old first network function instance to the first node.

12. A method comprising:
transmitting, by an information processing device, to a first node out of a plurality of nodes in each of which at least one container is deployed, a first request for instruction to move one or more containers deployed in the first node to a second node out of the plurality of nodes; and
transmitting, by the information processing device, an instruction for transition to a power saving state to the first node when no container is present on the first node.

13. The method according to claim 12, further comprising:
transmitting, by the information processing device, the first request to a plurality of the first nodes; and
transmitting, by the information processing device, the instruction for transition to the power saving state to the first nodes when no container is present on each of the first nodes.

14. The method according to claim 12, further comprising determining, by the information processing device, as the second node, a node included in a predetermined number of top nodes where a larger number of containers are deployed out of the plurality of nodes.

15. The method according to claim 12, further comprising:
when the one or more containers deployed in the first node are not movable to the second node, determining, by the information processing device, as a new second node, a node included in a predetermined number of top nodes where a larger number of containers are deployed out of the plurality of nodes; and
transmitting, by the information processing device, to the first node, the first request for instruction to move the one or more containers deployed in the first node to the new second node.

16. The method according to claim 12, further comprising executing, by each of the nodes:
when the first request is received from the information processing device, determining whether to execute movement of the one or more containers to the second node;
when determination is made to execute the movement of the one or more containers to the second node, executing a process related to the movement of the one or more containers to the second node; and
when determination is made not to execute the movement of the one or more containers to the second node, notifying the information processing device that the movement of the one or more containers to the second node is not to be executed.

17. The method according to claim 16, further comprising executing, by each of the nodes:
monitoring a power consumption of the one or more deployed containers; and
when the first request is received, determining whether to execute the movement of the one or more containers to the second node based on the power consumption of the one or more containers and a maximum power consumption and a current power consumption of the second node.

18. The method according to claim 12, wherein the container is an instance of any network function in a core network of a fifth-generation mobile communication network.

19. The method according to claim 18, further comprising:
when the container is newly deployed in the second node as a new first network function instance after the first request is transmitted, transmitting, by the information processing device, to a second network function instance, a second request for instruction for switching from an old first network function instance deployed in the first node to the new first network function instance deployed in the second node; and
when the switching from the old first network function instance to the new first network function instance is completed, transmitting, by the information processing device, an instruction to delete the old first network function instance to the first node.

20. An information processing device comprising a control unit configured to:
transmit, to a first node out of a plurality of nodes in each of which at least one container is deployed, a first request for instruction to move one or more containers deployed in the first node to a second node out of the plurality of nodes; and
transmit an instruction for transition to a power saving state to the first node when no container is present on the first node.
